(19) United States
(12) Patent Application Publication
(10) Pub. No.: US 2007/0180678 A1
(43) Pub. Date: Aug. 9, 2007

(54) Robot system and method for bolt removal from SAG and/or ball mills in ore concentration processes

(76) Inventor: Hugo Salamanca, Santiago (CL)

Correspondence Address: Hugo Salamanca P., Av. Suecia 84, Oficina 43, Providencia, Santiago, RM, CL

(21) Appl. No.: 11/598,096

(22) Filed: Nov. 13, 2006

Related U.S. Application Data
(60) Provisional application No. 60/734,976, filed on Nov. 10, 2005.

(51) Int. Cl. B23P 19/02

(52) U.S. Cl. 29/426.4

(57) ABSTRACT

At present, the removal of the bolts which fasten the liners should be carried out manually as part of the maintenance procedure SAG mills should be subjected to. The disadvantage of this procedure is the fact it should be carried out manually which makes the system to lose efficiency due to the high maintenance periods. Due to the above, a robot system and method have been developed to carry out this task automatically, in order to automate the removal of bolts from SAG and/or ball mills and thus to decrease the time used for maintenance. The robotic system is composed mainly of a robotic manipulator of at least 5 degrees of freedom, and a gripping mechanism which allows, in a sequential and programmed way, to take, manipulate and release a number of fastening bolts from the SAG mill, which are moved through a defined path to a bolt receptacle.

### BACKGROUND

### Prior Art

Once the mineral is extracted from the mine, it must be subjected to a treatment to increase its purity. This metallurgical treatment is called concentration, which is carried out in a concentrating plant usually located near the production unit of the mine. This plant concentrates the minerals until their metal content reaches commercial values. The stages of this process are crushing and milling (the progressive reduction of particles until reaching sizes lower than one millimeter), followed by the flotation process using chemical reagents, where the valuable mineral (copper and molybdenum concentrates) is separated from the gangue (which is the worthless material, called tailing).

In the milling stage, special reactors called grinding mills are used in which the mineral comminution process is carried out (the process in which the particle is broken to a smaller size). This process is carried out by combining impact and abrasion under dry conditions or in a water suspension.

Such grinding machinery are provided with the so called liners which are generally used for the internal covering of the grinding machines. Due to the above, the inner wall of such machinery is also subjected to the impact and abrasion resulting from the material circulating inside, which leads to a constant wear of this surface. In order to absorb this permanent wear and not to damage the frame of the equipment, sacrifice parts called “liners” are installed, which are intended to improve the process through a geometry favouring the abrasion and impact among the particles the equipment. The liners should be replaced on a regular basis so as to avoid permanent damages to the equipment frame.

As part of the maintenance process SAG mills should be subjected to, the bolts which fasten the liners should be removed manually with hydraulic tools.

From the economic point of view, one of the major disadvantages which presents the current methods used for bolt removal is the long time maintenance takes, which generates a loss in the equipment productivity due to the fact production is reduced because of mill stoppage.

Another disadvantage of the current methods for bolt removal is safety, due to the fact the personnel should go inside the equipment to remove the bolts, which is usually a risky operation, mainly due to the fact some elements which are trapped between the liners fall down.

Due to the above, a robot system and method have been developed which allow to carry out an automated bolt removal process into the SAG mills, so as to diminish the time spent for maintenance.

### SUMMARY

A robotic system and a robotized method have been developed for slag and/or matte discharge proceedings from the smelting furnaces allowing to carry out necessary tasks in a automated way. These tasks are: Punching and tapping the exit passages, sampling the different materials and cleaning the exit channels

### DRAWINGS

### Figures

In the drawings, closely related figures share the same numbers, with different alphabetic suffixes.

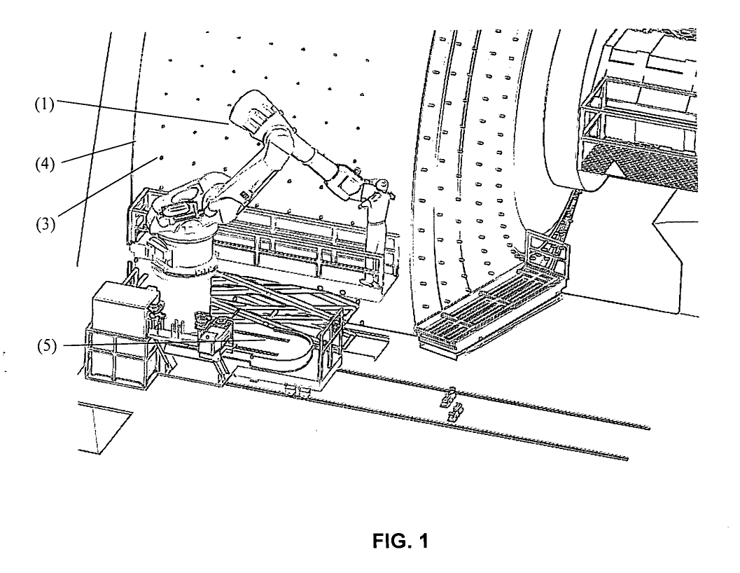

FIG. 1. View of the robotic manipulator removing a bolt in a SAG and/or ball mill.

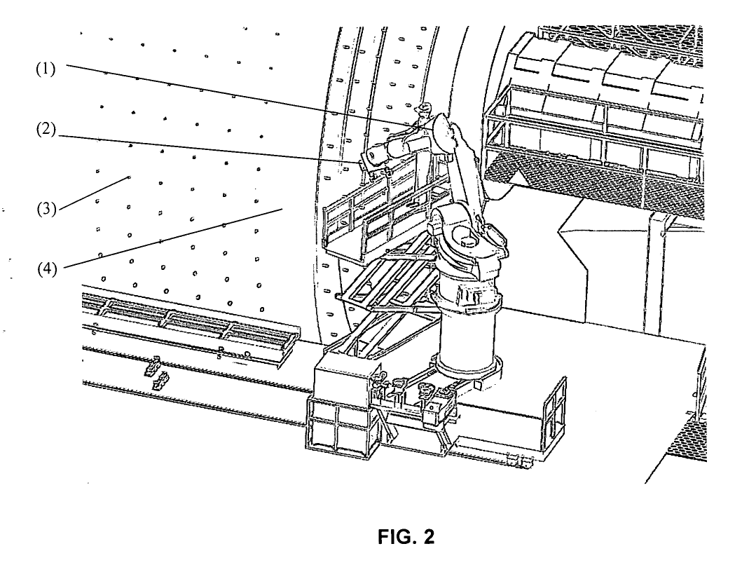

FIG. 2. General view of a robot system for bolt removal in SAG and/or ball mills in ore comminution processes.

### DRAWINGS

### Reference Numerals

1. Robotic manipulator

2. Gripping mechanism

3. Fastening bolts

4. SAG or Ball mills

5. Bolts disposal

### DETAILED DESCRIPTION

This invention relates to a new robot system as well as a robotic method for bolt removal in SAG and/or ball mills, which are carried out automatically through anthropomorphous robotic arms of at least 5 degrees of freedom, which are installed at one side of the SAG mill.

With reference to FIG. 1 and FIG. 2, the robot system is composed mainly of one robotic manipulator (1) of at least 5 degrees of freedom, provided with a communication, acquisition and control system, and a gripping mechanism (2) to allow, in a sequential and programmed way, to take, manipulate, and release a number of fastening bolts (3) of the SAG (4) and/or Ball mill to be defined which are moved through a defined path until reaching a bolt disposal facility (5).

I claim:

17. A robot system for bolt removal from SAG and/or ball mills in ore comminution processes comprising an anthropomorphous robotic arm of at least 5 degrees of freedom, one control, communication and programming unit, one gripper adapter, one gripper, its fingers, one gripper pneumatic driving system, one electric supply system wherein the anthropomorphous robotic arm of at least 5 degrees of freedom is provided with a pneumatic gripping mechanism which allows in a sequential and programmed way to take, manipulate and release a fastening bolt within the work volume of the robotic system, which are moved through a defined path, until reaching a bolt disposal facility.

2. A robot system for bolt removal from SAG and/or ball mills in ore comminution processes according to claim 1, wherein productivity and efficiency in the process of bolt removal from liners at SAG mills increases, by decreasing the time taken for the maintenance of this equipment.

3. A robot system for bolt removal from SAG and/or ball mills in comminution processes according to claim 1, wherein it could be integrated to the fastening bolt removal not only in ore comminution processes of metals such as copper, molybdenum, zinc, lead, etc. but also it could be used to carry out the activities of bolt removal of liners in SAG and/or ball mills, in a selective or supplementary way, in a wide range of other industrial productive processes.

4. A robot system for bolt removal in ore comminution processes according to claim 1, wherein the anthropomorphous robotic manipulator could communicate by itself or through a PLC interface with the control system.

5. Robotic system for bolt removal from SAG and/or ball mills in ore comminution processes, according to claim 1 wherein the anthropomorphous robotic manipulator is capable of obtaining and interpreting the information from analogue and/or digital installed sensors.

6. A robot system for bolt removal from SAG and/or ball mills in ore comminution processes according to claim 1, wherein the anthropomorphous robotic manipulator has the capacity to generate analogue and/or digital signals to control analogue and/or digital input devices.

7. A robot system for bolt removal from SAG and/or ball mills in ore comminution processes according to claim 1, wherein the system has the capacity to move, manipulate and release the fastening bolts in different paths within the work volume of the robotic system.

8. A robot system for bolt removal from SAG and/or ball mills in ore comminution processes according to claim 1, wherein the robotic manipulator of at least 5 degrees of freedom is mounted on a mobile support located at one side of the SAG and/or ball mill.

9. A robot system for bolt removal from SAG and/or ball mills in ore comminution processes according to claim 1, wherein a pneumatic gripping mechanism is used to take, manipulate and release the fastening bolts of liners in SAG and/or ball mills.

10. A robotic system for bolt removal from SAG and/or ball mills in ore comminution processes according to claim 1, wherein a pneumatic gripping mechanism is used, provided with fingers which allows to grasp and release the fastening bolts of liners in SAG and/or ball mills.

11. A robotic system for bolt removal from SAG and/or ball mills in ore comminution processes according to claim 1, wherein the anthropomorphous robotic manipulator is provided with an electrical supply system driven by three-stage induction motors with vectorial and/or scalar control

12. A robotic system for bolt removal from SAG and/or ball mills in ore comminution processes according to claim 1, wherein a mobile bolt disposal facility is used, which is within the work volume of the robot and is used to dispose the fastening bolts of liners in SAG and/or ball mills.

13. A robotic system for bolt removal from SAG and/or ball mills in ore comminution processes, according to claim 1, wherein productivity and efficiency in bolt removal of liners in ore concentration processes of different metals increases.

14. A robot system for bolt removal from SAG and/or ball mills in ore comminution processes according to claim 1, wherein the system may operate automatically, or semi-automatically, and also allows solutions scalability.

15. A robotic system for bolt removal from SAG and/or ball mills in ore comminution processes according to claim 1, wherein the system could be integrated to the removal of bolts for liners in SAG and/or ball mills.

16. A robotic system for bolt removal from SAG and/or ball mills according to claim 1, wherein it prevents the plant personnel from being subjected to a physical demand and harsh environmental conditions.

17. A robotic method for bolt removal from SAG and/or ball mills in ore comminution processes using the robot System of claim 1 to 16, wherein the anthropomorphous robotic arm of at least 5 degrees of freedom is provided with a pneumatic gripping mechanism which allows in a sequential and programmed way to take, manipulate and release one fastening bolt within the work volume of the robotic system, which are moved through a defined path, until reaching the bolt disposal facility.

18. A robotic method for bolt removal from SAG and/or ball mills of ore comminution processes using the robot System of claim No 1 to No 16, wherein the anthropomorphous robotic manipulator could communicate by itself or through a PLC interface with the control system.

19. A robotic method for bolt removal from SAG and/or ball mills in ore comminution processes using the robot System of claim No 1 to No 16, wherein the anthropomorphous robotic manipulator has the capacity to obtain and interpret the information from installed analogue and/or digital sensors.

20. A robotic method for bolt removal from SAG and/or ball mills in ore comminution processes using the robot System of claim No 1 a la No 16, wherein the anthropomorphous robotic manipulator has the capacity to generate analogue and/or digital signals to control analogue and/or digital input devices.

21. A robotic method for bolt removal from SAG and/or ball mills in ore comminution processes using the robot System of claim No 1 a la No 16, wherein productivity and efficiency of bolt removal of liners in SAG mills decrease the time for maintenance of this equipment.

22. A robotic method for bolt removal from SAG and/or ball mills in ore comminution processes using the robotic System of claims 1 to 16, wherein the system could be integrated to fastening bolt removal not only in ore comminution processes of different metals such as copper, molybdenum, zinc, lead etc., but also it could be used for bolt removal of liners in SAG and/or ball mills, either individually or in collaboration, in a wide range of other industrial productive processes.

23. A robotic method for bolt removal from SAG and/or ball mills in ore comminution processes using the robot System of claim No 1 to No 16, wherein the robotic manipulator has the capacity to take, manipulate and release the fastening bolts in different paths within the work volume of the robotic system.

24. A robotic method for bolt removal from SAG and/or ball mills in ore comminution processes using the robot System of claim No 1 to No 16 wherein the anthropomorphous robotic arm of at least 5 degrees of freedom is mounted on a mobile support located at one of the sides of the SAG and/or ball mills.

25. A robotic method for bolt removal from SAG and/or ball mills in ore comminution processes using the robot System of claim No 1 to No 16, wherein a pneumatic gripping mechanism is used to take, and release the fastening bolts for liners in SAG and/or ball mills.

26. A robotic method for bolt removal from SAG and/or ball mills in ore comminution processes using the robot System of claim No 1 to No 16, wherein a pneumatic gripping mechanism is used provided with at least 4 fingers which allows to grasp and release the fastening bolts for liners in SAG and/or ball mills.

27. A robotic method for bolt removal from SAG and/or ball mills in ore comminution processes using the robot System of claim No 1 to No 16, wherein the anthropomorphous robotic manipulator has an electrical system driven by three-stage induction motors with vectorial and/or scalar control.

28. A robotic method for bolt removal from SAG and/or ball mills in ore comminution processes using the robot System of claim No 1 to No 16, wherein a fixed bolt disposal facility is used, which is within the work volume of the robot and is used to dispose the fastening bolts of liners in SAG and/or ball mills

29. A robotic method for bolt removal from SAG and/or ball mills in ore comminution processes using the robot System of claim No 1 to No 16, wherein productivity and efficiency of bolt removal of liners in comminution processes of different metals increases.

30. A robotic method for bolt removal from SAG and/or ball mills in ore comminution processes using the robot System of claim No 1 to No 16, wherein the system may operate automatically, semi-automatically and also it allows solutions scalability.

31. A robotic method for bolt removal from SAG and/or ball mills in ore comminution processes using the robot System of claim No 1 to No 16, wherein the system may be integrated to the removal of liner bolts in SAG and/or ball mills.

32. A robotic method for bolt removal from SAG and/or ball mills in ore communition processes using the robot System of claim No 1 to No 16, wherein it prevents the plant personnel from being subjected to a high physical demand and a harsh environmental conditions.
